(19) United States
(12) Patent Application Publication
(10) Pub. No.: US 2013/0237399 A1
(43) Pub. Date: Sep. 12, 2013

(54) CENTRIFUGE COMPRISING VISUAL AND/OR TACTILE INDICATOR FOR INDICATING THE ACCURATE MOUNTING OF THE ROTOR ON THE DRIVE SHAFT, AND CORRESPONDING ROTOR

(71) Applicants: Micheline Lambert, (US); Aude Lambert, (US); July Lambert, (US)

(72) Inventors: Jean-Claude Letourneur, Pornichet (FR); Philippe Le Guyader, Poligne (FR); Roland Lambert, Le Grave (FR); Jean-Louis Fondin, Saint Lyphard (FR)

(73) Assignee: AWEL INTERNATIONAL, Blain (FR)

(21) Appl. No.: 13/508,289

(22) PCT Filed: Nov. 4, 2010
(86) PCT No.: PCT/EP10/66821

§ 371 Date: Mar. 8, 2013

(30) Foreign Application Priority Data
Nov. 4, 2009 (FR) 0905278

(51) Int. Cl. B04B 9/00

(52) U.S. Cl. CPC B04B 9/00
USPC 494/10

(57) ABSTRACT

A centrifuge is provided, which includes a drive shaft and a rotor intended to be removably mounted on the drive shaft in a mounting position. The drive shaft and the rotor are rotatably linked. The centrifuge also includes an axial locking device, which locks the rotor on the drive shaft and includes at least one male element supported by the rotor, resiliently biased and able to engage with a female element on the drive shaft. The male element(s) is(are) linked to a visual and/or tactile indicator, providing a visual and/or tactile indication of the engagement of the male element(s) with the female element.

### CROSS-REFERENCE TO RELATED APPLICATIONS

This Application is a Section 371 National Stage Application of International Application No. PCT/EP2010/0066821, filed Nov. 4, 2010, which is incorporated by reference in its entirety and published as WO 2011/054906 on May 12, 2011, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of the designing and manufacture of centrifugation equipment. More specifically, the disclosure pertains to centrifuges used in the fields of biology to centrifuge the products contained in receptacles placed in housings made in the rotor or carried by the rotor.

### BACKGROUND OF THE DISCLOSURE

Classically, the centrifuge comprises:
a drive shaft,
a rotor designed to be mounted removably on the drive shaft in a mounting position for which the drive shaft and the rotor are coupled in rotation,
a device for the axial locking of the rotor on the drive shaft, comprising a male element carried by the rotor, elastically stressed and capable of occupying a position of cooperation with a female element presented by the drive shaft.

In centrifuges of this type, the axial locking of the rotor on the drive shaft must be obtained as reliably as possible. Indeed, during the operation of the centrifuge, an insufficient axial locking may entail a major risk of accident due to the untimely detachment of the rotor.

Various solutions have been proposed in the prior art to achieve an axial locking of the rotor on the shaft by means of coupling systems provided with axial locking systems that can be unlocked from the exterior. However, these devices require that the operator should mount the rotor on the drive shaft with great attention and high precision in order that the locking means will take a position in which they ensure highly efficient axial locking. Indeed, these locking means have to be positioned axially in an appropriate way, failing which the rotor can get disengaged from the drive shaft when the centrifuge is put into rotation or during its operation, with possibly drastic consequences in terms of deterioration of the equipment or, at worst, drastic consequences for the personnel present in the vicinity of the centrifuge.

One solution described in the patent document EP-0 712 667 has been proposed to overcome this drawback. According to this technique, the male element of the locking device is mounted on the rotor and unlocking means actuatable from the exterior of the rotor are designed to enable the operator to place the male element in a position where it is clear of the retaining hollow feature. At the same time, the free end of the drive shaft has guiding means working together with complementary means fixedly joined to the rotor to bring the rotor, during the engagement of the shaft in the rotor, to pivot about its axis from any unspecified starting angular position and descend along the shaft until it reaches a position in which the rotor is joined rotationally with the shaft, the male element being then pushed back elastically into the female element to ensure an axial locking of the rotor.

One advantage of this technique is that the male element and the female element can be made with a profile of a depth sufficient so that, when the rotor reaches its mounting position, there is an audible click loud enough to inform the operator that the locking has truly been engaged.

However, in most cases, a centrifuge is present in a room in which there are also other centrifuges and/or other apparatuses. The centrifuges and/or the other apparatuses present prove in practice to be relatively noisy during operation. As a result, it can happen that the operator mounting the rotor on the drive shaft of the centrifuge will not perceive the audible click which may be concealed by the surrounding ambient sound.

This may have the following consequences:
either the operator may repeat the operation until he is totally assured that the rotor is properly mounted on the drive shaft;
or the operation of the centrifuge may be launched whereas the mounting has not been done accurately.

Naturally, it is also possible that the mounting will have been done correctly.

In other words, it can be understood that even when there are locking means producing an audible click, the quality of the mounting of the rotor on the drive shaft remains random.

### SUMMARY

An illustrative embodiment of the present disclosure relates to a centrifuge, the design of which enables an operator to know unambiguously whether the axial locking of the rotor on the drive shaft has been properly done.

An embodiment of the invention provides a centrifuge of this kind that provides for optimal axial locking.

An embodiment of the invention provides a centrifuge of this kind in which the means for rotational coupling of the rotor with the drive shaft are simple in design and practical for the operator in terms of mounting.

An embodiment of the invention provides a centrifuge of this kind that enables the easy and speedy dismounting of the rotor from the drive shaft.

Thus, through an embodiment of the invention, the operator has available a simple and efficient means giving him a clear and unambiguous indication that the rotor has been accurately mounted on the drive shaft.

Indeed the operator, by a simple glance and/or a simple touch check (or “feel check”), can ascertain that the rotor is occupying a position on the drive shaft that ensures its axial locking.

The operator will thus be perfectly reassured, and will be able to launch the centrifugal operation in total safety.

According to the principle of an embodiment of the invention, the rotor carries an annular cage provided with at least one radial passage through which said visual and/or tactile indicator is configured to be presented in protrusion, said male element being pivotally mounted about a pivoting pin parallel to the axis of said drive shaft.

Thus, when the indicator protrudes through the radial passage of the annular cage, the operator can:
either visually check the presence of indicator outside the annular cage, the indicator possibly also carrying a color code (such as a green patch) giving the “green light”;
or pass his fingers around the annular cage, the protruding presence of the indicator being thus easily detected by touch.

Furthermore, as shall be seen more clearly here below, the centrifuge effect caused by the rotation of the centrifuge may be profitably used to increase the cooperation of the male element or elements with the female element present on the drive shaft.

In this case, said male elements comprise, on one side of said pivoting pin, an engaging termination for engaging with said female element and, on the other side of said pivoting pin, an ear-shaped attachment that is to form visual and/or tactile indicator.

Such an arrangement enables a simple and efficient operation wherein, when the engaging termination penetrates the female element of the drive shaft, the corresponding male element pivots in such a way that the corresponding ear-shaped attachment gets off-centered and provides a visual and/or tactile indication.

Advantageously, said male element or elements are mounted at the upper part of the rotor.

Thus, the male element or elements occupy a position that easily enables the operator to check the visual and/or tactile indication.

According to another characteristic of an embodiment of the invention, the rotor carries a diametral rod designed to get housed in a diametral slot of said drive shaft to ensure the rotational coupling of said rotor with said drive shaft.

Thus, a simple and efficient coupling is obtained, involving operations for manufacture and mounting that are simpler than the classic prior-art solutions resorting to snugs and/or cotter pins penetrating the housings and/or the grooves of the drive shaft.

In this case, said rod is mounted in a cap overhanging said annular cage.

Advantageously, said rotor has means for identifying the orientation of said rod.

Thus, the operator, can easily orient the rotor relatively to the drive shaft in making the identifying means coincide with the orientation of the slot of the drive shaft visually located beforehand.

It will be noted that another types of rotational coupling can be implemented without departing from the framework of the invention, for example through the use of a grooved or hexagonal drive shaft, the rotor then having a central hollow with a corresponding shape.

According to another characteristic of an embodiment of the invention, the centrifuge comprises means for compensating for axial clearances, these means advantageously comprising a ring mounted slidingly on the drive shaft and against which the rotor is to take support, a spring being coupled to said ring and to said shaft so as to act in compression against the downward thrust of said rotor.

It will be noted that such compensation means fulfill a twofold function:
that of compensating for the axial clearance between the male element or elements and the female elements presented by the drive shaft so as to axially press the male element or elements on the interior of the female element;
that of facilitating the withdrawal of the rotor from the drive shaft, by exerting an upward thrust on the rotor when the male element or elements are disengaged from the female element of the drive shaft.

An embodiment of the invention also pertains to a rotor designed to be mounted removably on a drive shaft of a centrifuge, in a mounting position for which said drive shaft and said rotor are rotationally coupled, said rotor carrying at least one male element, elastically stressed and capable of occupying a position of cooperation with a female element presented by said drive shaft so as to ensure axial locking of the rotor on said drive shaft, characterized in that said male element or elements are coupled to a visual and/or tactile indicator giving a visual and/or tactile indication of said position of cooperation of said male element or elements, the rotor carrying an annular cage provided with at least one radial passage through which said visual and/or tactile indicator is to be presented in protrusion, and said male element or elements being mounted pivotally about a pivoting pin parallel to the axis of said drive shaft.

### BRIEF DESCRIPTION OF THE DRAWINGS

Other features and advantages shall appear more clearly from the following description of an embodiment of the invention, given by way of an illustratory and non-exhaustive example and from the appended drawings of which:

FIG. 1 is a view in perspective of the driving means and of an axial locking device of a centrifuge according to an embodiment of the invention;

FIG. 2 is a top view of the active part of the axial locking device of a centrifuge according to an embodiment of the invention;

FIG. 3 provides a schematic illustration in vertical section of a centrifuge according to an embodiment of the invention;

FIG. 4 is a detailed view of the rotor of a centrifuge according to an embodiment of the invention;

FIGS. 5 and 6 are partial top views of the locking device for locking a centrifuge according to an embodiment of the invention, respectively in the unlocked position and in the locked position;

FIG. 7 is a partial view of the lid and of the means for axial locking of the rotor on the drive shaft of a centrifuge according to an embodiment of the invention;

FIGS. 8 and 9 are top views of the means for axial locking of the rotor on the drive shaft of a centrifuge according to an embodiment of the invention, respectively in the locked position and in the unlocked position;

FIGS. 10 and 11 illustrate curves of signals detected by tachometric means of a centrifuge according to an embodiment of the invention, respectively in the locked position and in the unlocked position of the means for axial locking of the rotor on the drive shaft.

### DETAILED DESCRIPTION OF ILLUSTRATIVE EMBODIMENTS

As indicated here above, the principle of an embodiment of the invention lies in the fact of associating, in a centrifuge, elements for the axial locking of the rotor on the drive shaft with a visual and/or tactile indicator providing a visual and/or tactile indication when the male element or elements of the axial locking device are in a position of cooperation with the female element of the drive shaft.

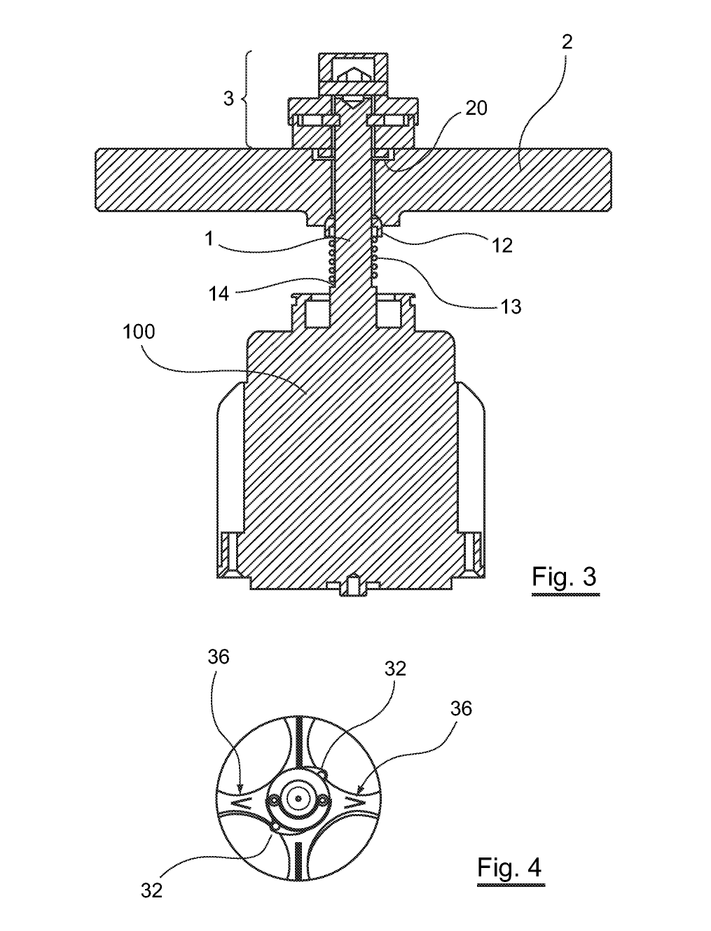

Referring to FIG. 3, a centrifuge according to an embodiment of the invention, in a manner known per se, comprises a vessel (not shown) incorporating:
a motor unit 100 connected to a drive shaft 1;
a rotor 2 mounted removably on the drive shaft 1, in a mounting position for which the drive shaft and the rotor are rotationally coupled;
a device 3 providing for an axial locking of the rotor to the drive shaft.

According to the present embodiment, the axial locking of the rotor to the drive shaft is obtained by the implementing of:
an annular groove 10 made on the drive shaft forming a female element presented by the drive shaft;
a pair of male elements 300 carried by the rotor and capable of occupying a position of cooperation with the annular groove 10 in being engaged in it under the action of an elastic stress.

According to the principle of an embodiment of the invention, the male elements 300 are coupled to visual and/or tactile indicating means (described in greater detail here below) providing a visual and/or tactile indication of the position of cooperation of the male elements 300 with the annular groove 10 of the drive shaft, i.e. the position when the male elements are engaged in the annular groove (the axial locking of the rotor to the drive shaft being then ensured).

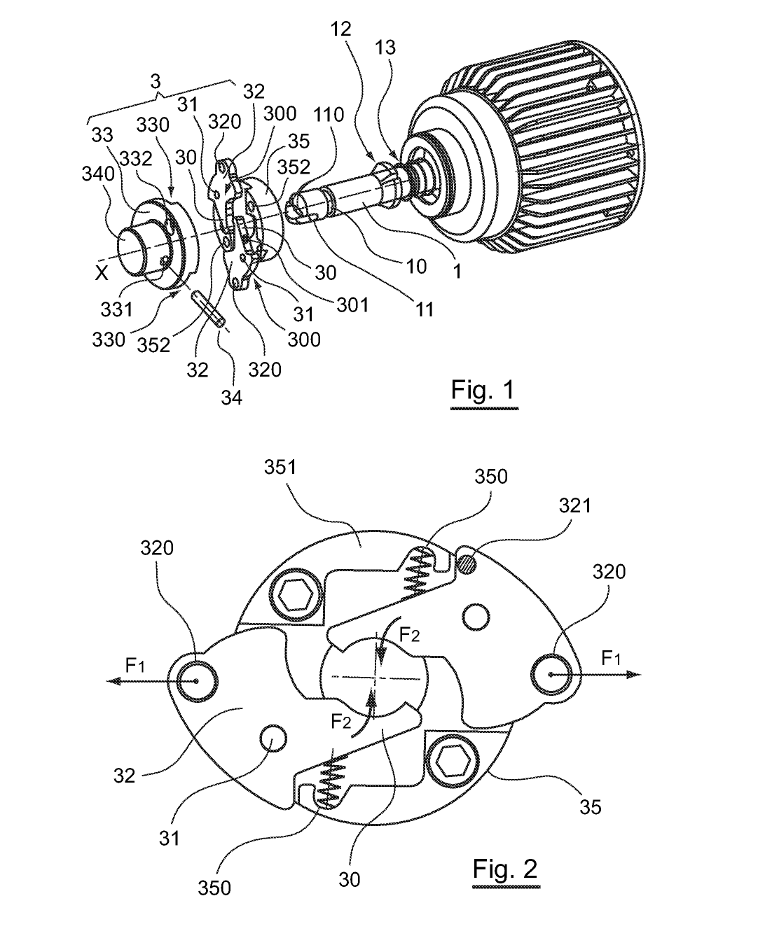

Referring to FIGS. 1 to 3, a more detailed description is provided here below of the device 3 providing for the axial locking of the rotor to the drive shaft.

As can be seen in these figures, the device 3 comprises a pair of male elements 300 each mounted so as to be pivoting about a pivoting pin 31 parallel to the axis X of the drive shaft, the pivoting pin 31 of each male element being mounted on a ring 35 embedded in a housing 20 prepared on the upper part of the rotor 2.

Thus, and as can be seen in FIG. 3, the device 3 and therefore the male elements 300 of the device 3 are mounted in the upper part of the rotor 2.

The male elements 300 are mounted so as to be diametrically opposite to each other relatively to the axis X on the ring 35. The same is therefore the case for the diametrically opposite positions of the pivoting pins 31.

Furthermore, each male element 300 is elastically stressed by a spring 301, one end of which takes support on a male element while the other end is housed in a cavity 350 of the ring 35, this spring 301 being designed and mounted so as to act in compression in such a way that each spring 301 tends to make the corresponding male element pivot towards its position of cooperation with the annular groove 10 of the drive shaft.

More specifically, each male element 300 comprises:
an engaging termination 30 extending on one side of the pivoting pin 31 and against which the spring 301 takes support, this engaging termination 30 being designed to get engaged in the annular groove 10 of the drive shaft to ensure the axial blocking of the rotor on the drive shaft;
an ear-shaped attachment 32 extending on the other side of the pivoting pin relatively to the engaging termination, this ear-shaped attachment forming a visual and/or tactile indicator as explained here below.

It can be noted that the angular play of the engaging termination 30 of each male element 300, in the direction along which the termination is off-centered relatively to the axis X is limited by a shoulder 351 made on the ring 35.

At the same time, the diametrically opposite shoulders 351 mutually make a space in which the ear-shaped attachments 32 extend, this space between the shoulders being also designed to enable an angular play of the ear-shaped attachments 32.

Furthermore, the rotor 2 has an annular cage 33 designed to be attached and fixed to the ring 35, this annular cage 33 demarcating a volume forming a housing for the male elements 300.

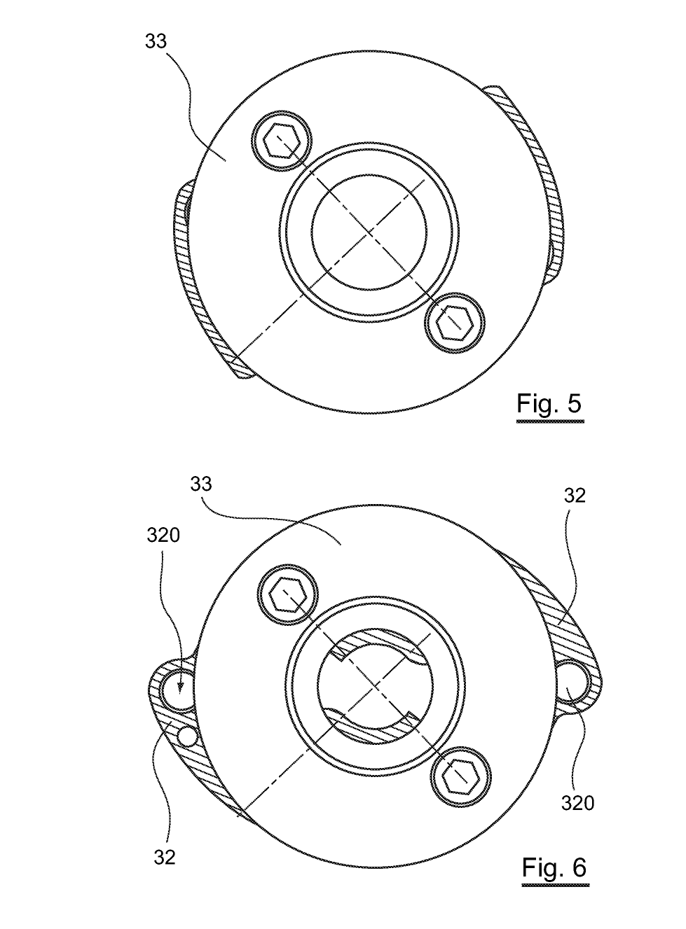

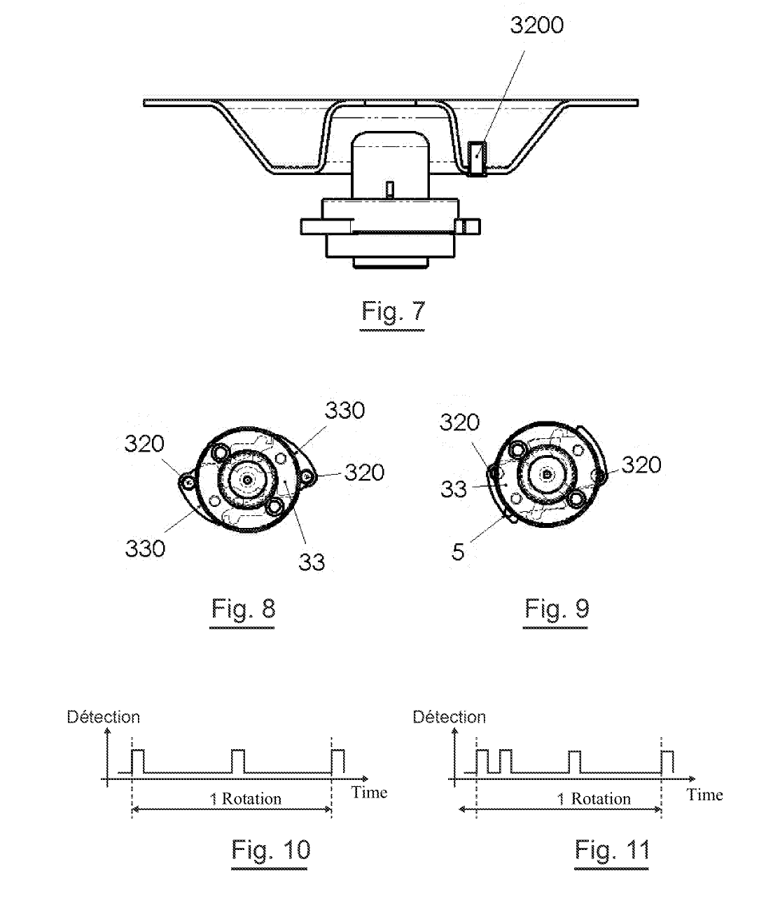

Furthermore, the annular cage 33 is provided with a radial passage 330 for each ear-shaped attachment 32. These radial passages 330 and this sizing of the diameter of the annular cage 33 are designed so as to permit two positions for the visual and/or tactile indicator constituted by the ear-shaped attachments 32, namely:
a position of concealment in which the ear-shaped attachments are housed integrally within the annular cage, the ear-shaped attachments being therefore neither visible nor accessible to touch (or almost non-accessible to touch) in this position (FIG. 5);
a position for indicating the axial locking of the rotor on the drive shaft in which the ear-shaped attachments protrude through the passages 330 of the annular cage 33, the ear-shaped attachments being then presented outside the annular cage so as to be visible and accessible to being touched (as can be seen in FIGS. 4 and 6).

To further increase the visible nature of the ear-shaped attachments when they are made to protrude through the radial passages 330 of the annular cage, a color indicator 320 (for example green) is attached to the upper face of each ear-shaped attachment 32.

The axial locking of the rotor on the drive shaft is obtained by the device 3 which has just been described.

Furthermore, the centrifuge also has a device to measure the rotational speed of the centrifuge, the device comprising:
a first part called an emitter carried by the rotor 2;
a second part capable of detecting a frequency of passage of the emitter part at a fixed point, this second part being mounted preferably on the lid 40 of the centrifuge.

These first and second parts constitute a tachometric device by which it is possible to obtain the rotation speed of the rotating assembly constituted by the rotor.

According to the present embodiment, the emitting part carried by the rotor is constituted by the indicators 320, each of them being a magnet. In parallel, the second part capable of detecting a frequency of passage of the emitter part is a radio-magnetic effect sensor 3200 carried by the lid (this sensor being therefore at a fixed point of the centrifuge once the lid is closed).

Furthermore, according to another aspect of an embodiment of the invention illustrated by FIGS. 8 to 10, one of the male elements 300 of the axial locking device 3 has a target element 321 while the chamber, and preferably the lid according to the present embodiment, carries a device for locating the target element 321, this assembly being designed to detect the axial positioning of the rotor on the drive shaft in the position corresponding to the position of cooperation of said male element with the annular groove 10 of the drive shaft 1.

This target element is constituted according to the present embodiment by a magnet mounted at one corresponding end of the ear-shaped attachment 32 opposite the end receiving the indicator 320 relatively to the pivoting pin 31. It can be noted that, according to this device, when the axial locking device is in an unlocked position, the magnet 321 is presented outside the annular cage 33 (FIG. 9) while, inversely, when the axial locking device is in the locked position, the magnet 5 is concealed within the annular cage 33 (FIG. 8).

Thus, when the rotor rotates and when the axial locking device is in a locked position (FIG. 8), the radio-magnetic effect sensor 3200 will emit a signal corresponding to a curve of the type shown in FIG. 10: two signals evenly spaced out corresponding to the passages of the indicators 320 beneath the radio-magnetic effect sensor 3200.

By contrast, when the rotor rotates and the locking device is not in a locked position (FIG. 9), the radio-magnetic effect sensor 3200 will emit a signal corresponding to the curve of the type shown in FIG. 11: three signals corresponding to the passages of the indicator 320 and of the magnet 5 beneath the radio-magnetic effect sensor 3200, these signals being spaced out unevenly in sets of two (the magnet 321 being closer to one of the indicators 320 than to the other). In this case, the curve is interpreted as representing an unlocked position of the rotor on the drive shaft and the centrifugation cycle is immediately stopped.

The rotational coupling of the rotor with the drive shaft is obtained by the implementing of the constituent parts described here below.

As can be seen in FIG. 1, the rotational coupling of the rotor with the drive shaft comprises:
firstly, a diametral slot 11 extending from the upper end of the drive shaft 1;
a diametral rod fixed to the rotor, designed to get housed in a diametral slot 11 of the drive shaft to provide for the rotational coupling of the rotor with the drive shaft.

This rod 34 is force-fitted into a cap 340 overhanging the annular cage 33 (the cap 340 and the annular cage forming one and the same part), the rod 34 being introduced through two holes 331 made in the cap 340 so as to be diametrically opposite to each other.

It can be noted that the annular cage 33 (and therefore the cap 340) is fixedly joined to the rotor by screwing elements that go through holes 332 made in the annular cage 33 and holes 352 made in the ring 35 (the holes 352 of the ring 35 are made so as to be placed in correspondence with the holes 332 of the annular cage 33); the result of this assembly is that the rod 34 is joined rotationally to the rotor 2.

Furthermore, the rotor has a device for identifying 36 (FIG. 4) the orientation of the rod 34 so as to enable an operator to present the rotor in an angular position in which the rod is in the alignment of the diametral slot 11 of the drive shaft 1.

According to another characteristic illustrated by FIG. 3, a slotted conical ring 12 is mounted so as to be sliding on the drive shaft 1 and a spring 13 is interposed between the ring 12 and a shoulder 14 made on the drive shaft, this spring 13 acting in compression and tending to push back the ring 12 towards the upper end of the drive shaft.

The mounting of this ring 12 is designed so that the rotor takes support, by its lower face, on the ring 12.

Thus, the ring 12 and the spring 13 constitute a device for compensating for the axial clearances between the constituent parts of the rotor 2 and the annular groove of the drive shaft.

The mounting of the rotor on the drive shaft of a centrifuge according to an embodiment of the invention is done as follows.

The operator grasps the rotor and orients it angularly so as to align the identifying device 36, indicating the orientation of the rod 34, with the diametral slot 11 of the drive shaft that the operator has preliminarily visualized.

The presence of chamfers 110 on either side of the slot 11 at the end of the drive shaft makes it possible to move the engaging terminations 30 of the male elements apart from one another, enabling the rotor to get engaged in the drive shaft.

The operator then engages the rotor on the drive shaft. The pressure on the ear-shaped attachments of the male elements can be released, the engaging terminations then sliding, in being supported on the external surface of the drive shaft. The rod 34 gets engaged in the diametral slot of the drive shaft.

The operator continues the engagement of the rotor on the drive shaft until the engaging terminations reach the annular groove 10 of the drive shaft. At this stage, under the action of the springs 301, the engaging terminations 30 penetrate the annular groove 10 of the drive shaft.

The simple fact of placing the engaging in correspondence with the location of the annular groove 10 of the drive shaft is enough to give rise to the pivoting of the male elements about their pivoting pin 31, as indicated by the arrow F2 in FIG. 2.

The pivoting of the male elements tends to bring the engaging terminations into a position of cooperation with the annular groove of the drive shaft accompanied by the shifting of each ear-shaped attachment 32 through the corresponding radial passage 330 of the annular cage 33 until the ear-shaped attachments are brought into a position in which they are presented in protrusion through these radial passages and give a visual and tactile indication, indicating that the axial locking of the rotor on the drive shaft has been achieved.

It can be noted that when the engaging terminations reach the annular ring 10 of the drive shaft, the rotor reaches a position in which it is supported on the ring 12 mounted slidingly on the drive shaft and presses lightly on this ring. This tends to slightly compress the spring 13 which pushes the rotor back upwards. The result of this is that the terminations are also pushed upwards and are made to abut the interior of the annular ring. The axial play between the thickness of the engaging terminations and the height of the annular groove is thus compensated for.

It can be noted that, during the centrifugation, the rotation of the rotor gives rise to a centrifugal effect on the male elements 300 as illustrated by the arrow F1 in FIG. 2. This centrifugal effect tends to increase the gripping force of the terminations for engaging within the annular groove 10 of the drive shaft. The centrifugal effect (illustrated by the arrows F1) thus substantially increasing the clamping force (forces F2 illustrated in FIG. 2) of the male elements on the drive shaft.

To withdraw the rotor from the drive shaft once the centrifugation is terminated, it is enough for the operator to press the ear-shaped attachments 32 so as to make them penetrate the annular cage 33: this corresponds to a spreading of the engaging terminations apart from each other until they are brought outside the annular groove 10. At this stage, the spring 13 which had been hitherto compressed tends to push the rotor back upwards through the sliding ring 12.

The operator can then continue the disengagement of the rotor effortlessly.

1. A centrifuge comprising:
a drive shaft having an axis,
a rotor configured to be mounted removably on the drive shaft in a mounting position for which the drive shaft and the rotor are coupled in rotation,
a device providing for an axial locking of the rotor on said drive shaft, comprising at least one male element borne by the rotor, elastically stressed and capable of occupying a position of cooperation with a female element presented by said drive shaft, wherein said at least one male element is pivotally mounted about a pivoting pin parallel to the axis of said drive shaft, and
a visual and/or tactile indicator coupled to said at least one male element and configured to procure a visual and/or tactile indication of said position of cooperation of said at least one male element with said female element, the rotor carrying an annular cage provided with at least one radial passage through which said visual and/or tactile indicator is designed to be presented in protrusion.

2. The centrifuge according to claim 1, said at least one male element comprises, on one side of said pivoting pin, a termination for engaging with said female element and, on the other side of said pivoting pin, an ear-shaped attachment that is to constitute the visual and/or tactile indicator.

3. The centrifuge according to claim 1, wherein said at least one male element is mounted at an upper part of said rotor.

4. The centrifuge according to claim 1, wherein the rotor carries a diametral rod configured to get housed in a diametral slot of said drive shaft to ensure the rotational coupling of said rotor with said drive shaft.

5. The centrifuge according to claim 4, wherein said rod is mounted in a cap overhanging said annular cage.

6. The centrifuge according to claim 4, wherein said rotor has means for identifying the orientation of said rod.

7. The centrifuge according to claim 1, wherein the centrifuge comprises means for compensating for axial clearances.

8. The centrifuge according to claim 7, wherein said means for compensating comprise a ring, which is mounted slidingly on said drive shaft and against which the rotor takes support, a spring being coupled to said ring and to said shaft so as to act in compression against a downward thrust of said rotor.

9. A rotor designed to be mounted removably on a drive shaft of a centrifuge, in a mounting position for which said drive shaft and said rotor are rotationally coupled, said rotor comprising:
at least one male element, elastically stressed and capable of occupying a position of cooperation with a female element presented by said drive shaft so as to ensure an axial locking of the rotor on said drive shaft, said at least one male element being mounted pivotally around a pivoting pin parallel to the axis of said drive shaft,
a visual and/or tactile indicator coupled to said at least one male element and configured to procure a visual and/or tactile indication of said position of cooperation of said at least one male element, the rotor carrying an annular cage provided with at least one radial passage through which said visual and/or tactile indicator is to be presented in protrusion.
